(19) United States
(12) Patent Application Publication
(10) Pub. No.: US 2007/0140382 A1
(43) Pub. Date: Jun. 21, 2007

(54) Bandpass sampling receiver and the sampling method

(75) Inventor: Xuecheng Qian, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/588,255

(22) PCT Filed: Dec. 1, 2004
(86) PCT No.: PCT/IB04/52611

§ 371 Date: Aug. 2, 2006

(30) Foreign Application Priority Data
Dec. 5, 2003 (CN) 2003012250

(51) Int. Cl. H04L 27/22

(52) U.S. Cl. 375/332; 329/304

(57) ABSTRACT

A bandpass sampling receiver is proposed for receiving RF signals, comprising: the first ADC, for converting the RF signal into the first path of digital signal under the control of the first sampling clock signal; the second ADC, for converting the RF signal into the second path of digital signal under the control of the second sampling clock signal; a signal separating unit, for separating the in-phase signal and the quadrature signal in the first path of digital signal and the second path of digital signal; wherein the frequency of said first sampling clock signal and said second sampling clock signal is l/N of that of said RF signal, and N is a natural number.

### FIELD OF THE INVENTION

The present invention relates generally to a radio signal receiver for use in wireless communications, and more particularly, to a radio signal receiver employing bandpass sampling.

### BACKGROUND ART OF THE INVENTION

In wireless communication, the user signal to be transmitted is usually baseband signal with relatively low frequency and limited bandwidth, and in general can be expressed by two orthogonal components as I(t)+jQ(t). The spectrum can be illustrated as in FIG. 1, where I(t) is the in-phase component and Q(t) is the quadrature component. When the user signal is to be transmitted, the transmitter modulates a carrier signal s, whose frequency is in RF (Radio Frequency) domain, with the user signal and then transmits the RF signal to radio space through the transmitting antenna.

The receiver receives the RF signal from radio space through the antenna, and converts it into baseband digital signal centred at zero frequency so that the wanted user signal meeting the BER (Bit-Error-Rate) requirement can be recovered through further baseband processing. In current wireless communication systems, most equipments still employ conventional super heterodyne receiver, with architecture as shown in FIG. 2. In FIG. 2, receiver 200 receives the RF signal via the antenna. The RF signal is first filtered by bandpass filter 220, and then amplified by LNA (Low Noise Amplifier) 221 and sent to down -converter 230. Down -converter 230 down-converts the received RF signal into IF (intermediate frequency) analog signal by exploiting a LO (local oscillator) signal, and the out-of-band interference in IF domain is rejected through IF filter 233. Afterwards, quadrature demodulation is performed on the IF signal in I/Q separating unit 240, to get two orthogonal baseband analog signals I(t) and Q(t). Lastly, the two paths of baseband analog signals are converted into digital signals in ADCs (Analog-to-Digital Converter) 250I and 250Q, and thus the wan ted user signal can be recovered through the decoding of demodulator 270.

During the procedure of converting the RF signal into baseband digital signal as shown in FIG. 2, IF filter 233 is indispensable, and the effect of IF filtering is directly related with the quality of the output signal. But in conventional super heterodyne receiver, IF filter 233 is implemented by bulky and expensive SAW (Surface Acoustic Wave) devices, making it very hard to be integrated with other circuits. Meanwhile, with the development of multi-mode handsets, the super heterodyne receiver needs a standalone IF SAW filter for every channel bandwidth in every mode, which increases the cost of receivers, and furthermore, the hardware constraints pose an obstacle to the upgrade of equipments. Moreover, analog mixers are used many times in the receiver, thereby problems like nonlinear effects and image frequency interference, is unavoidable.

To overcome the hardware constraints caused by using bulky devices such as IF filters, a solution is proposed to adopt ZIF (Zero-IF) receiver or direct conversion receiver architectures, to convert the RF signal directly into baseband signal by taking advantage of the LO signal having the same frequency as the RF carrier. Another solution is disclose d in US patent application document US20020181614A1, entitled “Sub -sampling RF receiver architecture”, issued on Dec. 5^{th}, 2002. In this solution, after being bandpass filtered and low-noise amplified, the received RF signal is sampled and filtered by using bandpass-sampling method, to get the baseband signal. The received signal at the receiver is actually a bandpass signal in which a band-limited signal (shown in FIG. 1) is modulated onto a HF carrier, and the lower sideband of the bandpass signal is much higher than the bandwidth of the passband, so sampling can be done by choosing a clock signal whose frequency is lower than the carrier frequency of the received signal, and thus some portion of high -order spectrum components of the sampled signal is placed between the lower sideband of the bandpass signal and zero frequency. The sampling frequency in bandpass sampling is significantly lower than the carrier frequency of the signal, and thus is also called as sub-sampling. Two kinds of sub-sampling receiver architectures are proposed in the patent document, which is incorporated herein as reference. Architecture of the first sub -sampling receiver is shown in FIG. 3. In FIG. 3, after being processed at RF bandpass filter 220 and LNA 221, the received RF signal is sent to sampler and holder 310, to be bandpass sampled at sampling frequency of

$${f}_{s} = \frac{{f}_{c}}{M + 1 / 4} > 2 B ,$$

wherein f_{c} is the carrier frequency, B is the user signal bandwidth for modulating the carrier, and M is any natural number. In this way, the sampled signal will have a high-order spectrum component of the user signal near zero frequency or namely at fₛ/4. ADC 320 is used for converting the sampled signal into digital signal. The converted digital signal will be quadrature modulated in digital domain independently at digital mixers 330I and 330Q. Digital mixers 330I and 330Q are used for moving the signal spectrum at fₛ/4 to zero frequency, so that orthogonal user digital signals can be recovered after being filtered by the digital lowpass filters.

In this sub-sampling receiver architecture, the analog mixers and the IF filters are omitted, but two digital mixers are needed to implement the second frequency conversion to move the spectrum of the signal to be demodula fed into baseband. Furthermore, a very high sampling frequency (higher than twice the bandwidth of the bandpass signal) is normally required in order to avoid aliases in the receiver. In practical systems, such as GSM mobile phone, it's generally very difficult to remove interference completely through RF bandpass filter 220, so the input signal of the sampling circuit often contains wideband interference. Therefore, the clock signal selected in practical applications often has a frequency much higher than the theoretical value, which often leads to low efficiency. Additionally, AD (Analog-to-Digital) conversion is needed for the user signal modulated on the carrier of fₛ/4, so the performance of the AD converter must be high enough.

To further simplify the receiver architecture, a two -path sub-sampling receiver architecture is disclosed in patent document US20020181614A1, as shown in FIG. 4. In FIG. 4, after passing through RF bandpass filter 220 and LNA 221, the received signal is first divided into two paths, and then respectively sampled by sampler and holder 410I and 410Q at frequency of

$${f}_{s} = \frac{{f}_{c}}{N} > B ,$$

wherein N is a natural number and a phase shift of 90 degree exists between the two paths of clock signals with frequency fi. In the architecture as shown in FIG. 4, the carrier frequency is multiple times the sampling frequency, so the nth-order spectrum component of the user signal will exist at zero frequency after sampling. The baseband analog signal at zero frequency can be filtered out through lowpass filters. And then baseband digital signal can be gotten after AD converting the baseband analog signal.

In this two-path sub-sampling method, processing of the digital mixer in the first sub-sampling receiver is omitted and the baseband signal can be AD converted directly. However, when the sampling frequency is chosen, if N is even, the two paths will get the same result after the signal is sampled, and thus we can't obtain the separated orthogonal user signal s I(t) and Q(t). Furthermore, the method as how to separate the orthogonal user signals is not disclosed fully in the patent document.

With regard to the above modified receiver architecture, bulky devices such as IF filter, are not used any more, but it s fill fails to depart from the idea that the RF signal is first converted into baseband analog signal and then AD converted. In new wireless communication systems, many communication protocols and technologies are updated constantly, thus a better method an d apparatus is needed for converting the received radio signal into baseband digital signal.

### SUMMARY OF THE INVENTION

In the present invention, wideband ADC is required to approach the receiving antenna as near as it can, and AD convert the RF signal directly, then various processing on the received signal should be implemented by programmable DSP (digital signal processing) devices as much as possible. DSP is flexible, costs less and is easy for integration, so this method can realize compatibility of multiple communication protocols and easy for technical upgrade.

Hence, based on analyzing the feasibility of the two-path sub-sampling method, this invention focuses on proposing a receiver architecture for AD converting the RF signal directly, and a specific method for recovering the wanted user signal as well.

One object of the present invention is to provide a simple bandpass sampling receiver architecture, for AD converting the RF signal directly, without resorting to analog mixers and digital mixers.

Another object of the present invention is to provide a simple bandpass sampling receiver architecture, for lowering the requirement for ADC performance as much as possible, and offer the method for recovering the orthogonal digital user signals.

A bandpass-sampling receiver is proposed for receiving RF signals, comprising: the first ADC, for converting the RF signal into the first path of digital signal under the control of the first sampling clock signal; the second ADC, for converting the RF signal into the second path of digital signal under the control of the second sampling clock signal; a signal separating unit, for separating the in-phase signal and the quadrature signal in the first path of digital signal and the second path of digital signal; wherein t he frequency of said first sampling clock signal and said second sampling clock signal is 1/N of the carrier frequency of said RF signal, and N is a natural number.

### BRIEF DESCRIPTION OF THE DRAWINGS

For a detailed description of the preferred embodiments of the invention, reference will now be made to the accompanying drawings in which:

FIG. 1 displays the frequency spectrum of the baseband user signal;

FIG. 2 is a block diagram illustrating the architecture of conventional super heterodyne receiver;

FIG. 3 is a block diagram illustrating the architecture of a normal sub-sampling receiver;

FIG. 4 is a block diagram illustrating the architecture of a normal two-path sub-sampling receiver;

FIG. 5 displays the frequency spectrum of the RF signal after the user signal is modulated;

FIG. 6 displays the frequency spectrum of the RF signal after being sampled with clock signal of

$${f}_{s} = \frac{{f}_{c}}{N} ;$$

FIG. 7 is a block diagram illustrating the architecture of the bandpass sampling receiver in an embodiment of the present invention;

FIG. 8 illustrates structure of the proposed equipment for generating quadrature sampling clock signal in an embodiment of the present invention.

### DETAILED DESCRIPTION OF THE INVENTION

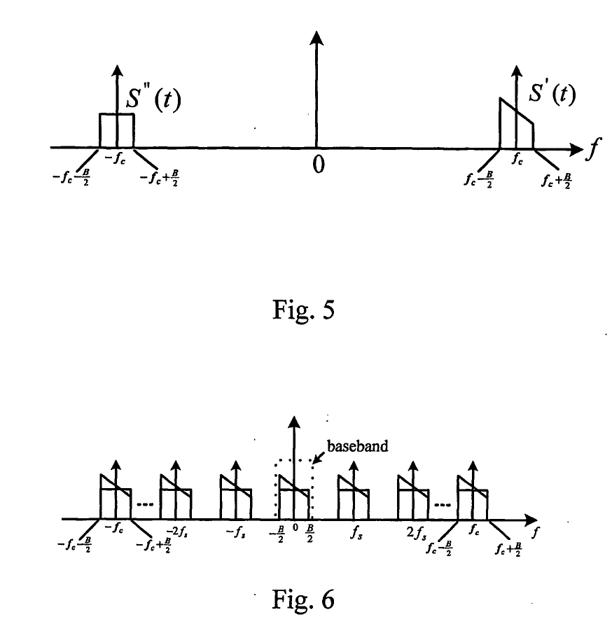

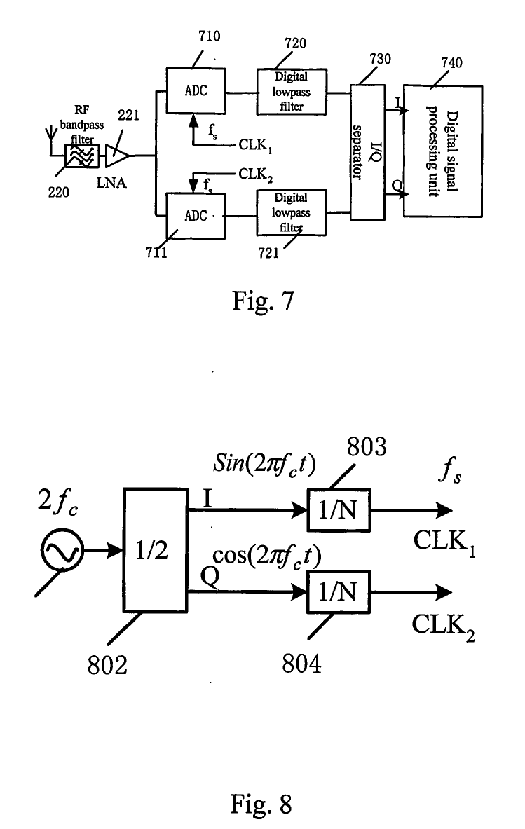

To clearly describe the features of the present invention, a n analysis will first be given below to the feasible conditions of the two -path sub-sampling receiver architecture in theory, in conjunction with FIG. 5 and FIG. 6, then a detailed description will go to the proposed receiver architecture in an embodiment of the present invention in conjunction with FIG. 7 and provide the method for recovering the user signal.

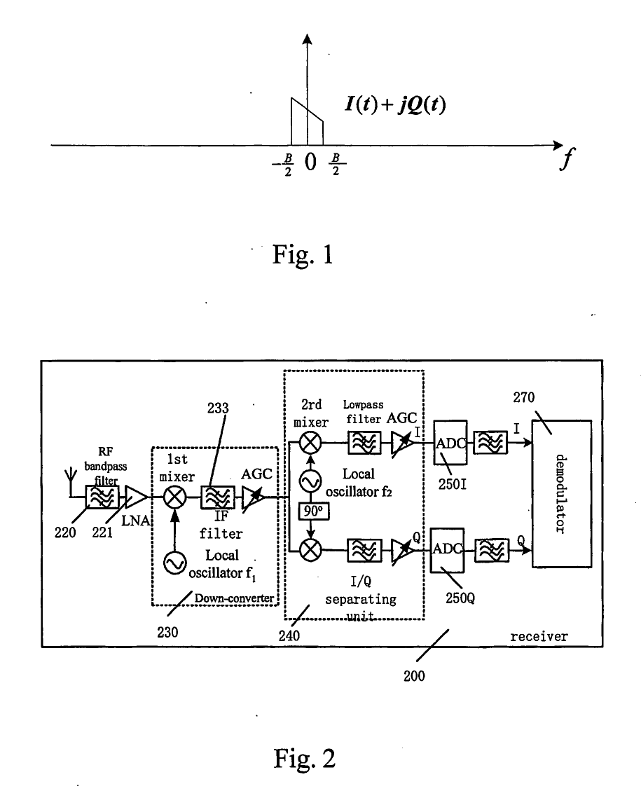

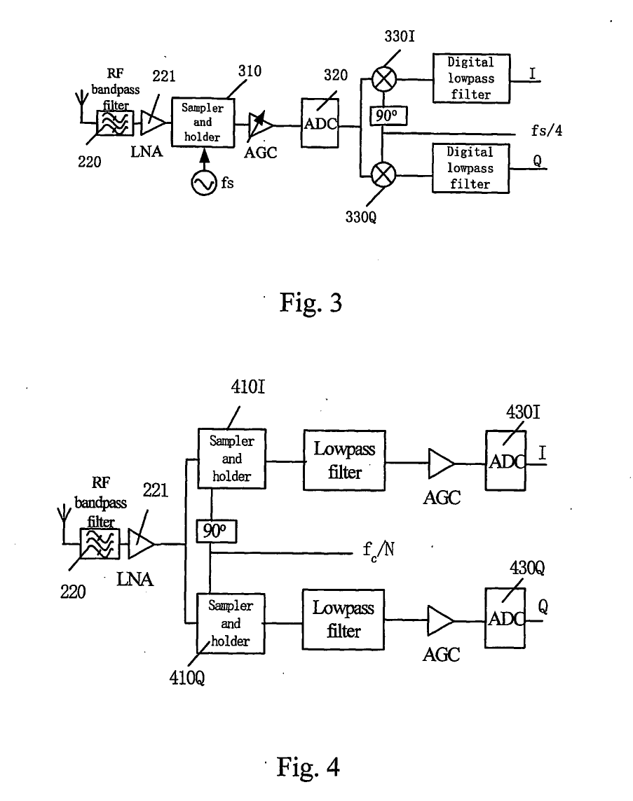

If the user signal with bandwidth as B shown in FIG. 1 can be expressed by two orthogonal components as I(t)+jQ(t), the RF signal with carrier frequency of f_{c} and quadrature modulated with the user signal can be given by:
S(t)=I(t)cos(ωₑt+φ)−Q(t)sin(ω_{c}t+φ) (1)
where ωₑ=2πf is the circular frequency of the carrier, and φ is the initial phase of the carrier.

For ease to analyze the spectrum characteristic of the RF signal, some necessary mathematical transforms can be made to equation (1), and thus S(t) can be further expressed as two bandpass components S′(f) and S″(t) with central frequencies as f_{c} and −f_{c} respectively:

$$\begin{matrix}{S}^{′} ( t ) = \frac{1}{2} \{ [ I ( t ) cos ( φ ) - Q ( t ) sin ( φ ) ] + j [ I ( t ) sin ( φ ) + Q ( t ) cos ( φ ) ] \} {ⅇ}^{j {w}_{c} t} & ( 2 ) \\ {S}^{″} ( t ) = \frac{1}{2} \{ [ I ( t ) cos ( φ ) - Q ( t ) sin ( φ ) ] + j [ I ( t ) sin ( φ ) + Q ( t ) cos ( φ ) ] \} {ⅇ}^{- j {w}_{c} t} & ( 3 )\end{matrix}$$

Its spectrum characteristic is shown in FIG. 5. As the figure shows, S′(t) and S″(f) in equation (2) and equation (3) have difference in amplitude and frequency, but have the same bandwidth.

When the RF signal is bandpass sampled, to avoid aliases, we can choose a clock signal with frequency as

$${f}_{s} = \frac{{f}_{c}}{N} > B .$$

The sampled signal spectrum equals to periodic continuation of the original RF signal spectrum (as shown in FIG. 5 ) with sampling frequency fₛ as the cycle in spectrum domain, as displayed in FIG. 6. It can be seen from FIG. 6 that the carrier frequency is N times the sampling frequency, superposition of the high-order spectrum components of S′(f) and S″(t) will occur at multiple time s the sampling frequency when spectrum is periodically continued. Thus, there will be a superposed spectrum component with bandwidth of B at zero frequency. The time domain of the signal centered to zero frequency (i.e. its carrier frequency is zero) can b e computed with equations (2) and (3), that is, I(t)cos(φ)-Q(t)sin(p). Apparently, due to aliases, the signal with zero carrier frequency is actually the linear combination of orthogonal user signals I(t) and Q(t). So it is unlikely to recover the separated orthogonal user signals I(t) and Q(t) by merely exploiting the filtered signal from the lowpass filter.

Therefore, two-path bandpass sampling is necessary to sample the RF signal by using two clock signals at the same frequency but with different phases, to get the linear combination of two different orthogonal user signals, and then I(t) and Q(t) of the user signal can be obtained through the separation procedure. Additionally, signal spectrum exists at zero frequency after sampling, so ADC can be used to convert the sampled signal into digital signal.

Base on the above ideas, the architecture of the proposed bandpass sampling receiver is shown in FIG. 7. In FIG. 7, the RF signal received at the antenna is filtered by bandpass filter 220 and amplified by LNA 221, divided into two paths, and then AD converted by ADC 710 and 711 respectively. The sampling clock frequencies of the two ADCs are both 1/N of the carrier frequency of the RF signal, but there is a fixed relative delay τ between-the sampling clocks CLK₁ and CLK₂ of the two ADCs. The purpose of introducing the relative delay π lies in that the sampling instants in the two paths correspond to two different carrier phases, and accordingly two different digital sequences can be obtained after AD conversion. The relative delay r is required to be much smaller than the reciprocal of

$$B ( i . e . , τ << \frac{1}{B} )$$

in order that the in-phase component I(t) and the quadrature component Q(t) keep almost constant during the period π. After the two AD converted digital sequences are filtered by digital lowpass filter 720 and digital lowpass filter 721 respectively, the zero frequency component (or namely the baseband digital signal) of the sampled digital sequences can be obtained. Finally, the two paths of baseband digital signals are sent to I/Q separator 730 for necessary digital signal processing, thus the two orthogonal components are separated and sent to subsequent DSP module 740, and the wanted user signal can be recovered through further processing, such as demodulation, decoding and etc.

In accordance with the architecture as shown in FIG. 7, when there exists the relative delay X between the sampling clocks CLK₁ and CLK₂ of the two ADCs, the two sampled baseband digital signals filtered by digital lowpass filter 720 and digital lowpass filter 721, can respectively be expressed as:

$$\begin{matrix}{S}_{1} ( t ) = I ( t ) cos ( {φ}_{1} ) - Q ( t ) sin ( {φ}_{1} ) & ( 4 ) \\ \begin{matrix}{S}_{2} ( t ) = I ( t + τ ) cos ( {φ}_{1} + {w}_{c} τ ) - Q ( t + τ ) sin ( {φ}_{1} + {w}_{c} τ ) \\ = I ( t ) cos ( {φ}_{2} ) - Q ( t ) sin ( {φ}_{2} )\end{matrix} & ( 5 )\end{matrix}$$

where φ₁ and φ₂ are the initial phases of the carrier relative to the two paths of sampling clocks CLK₁ and CLK₂, φ₂=φ₁+ω_{c}τ, and S₁(f) and S₂(f) represent the output signals of digital lowpass filters 720 and 721 respectively.

Meanwhile, if phase shift between CLK₁ and CLK₂ is 90 degree, that is

$$τ = \frac{1}{{ω}_{s}} \frac{π}{2} , and \frac{{ω}_{c}}{{ω}_{s}} = N ,$$

then

$${ω}_{c} τ = \frac{N}{2} π .$$

When N is even,

$${ω}_{c} τ = \frac{N}{2} π = n π$$

in equations (4) and (5), so equations (4) and (5) will be identical after being simplified, thus the wanted user signal cannot be recovered.

From the above analysis, only when ωₑτ≠nπ, the user signal can be recovered with the two-path bandpass sampling method, wherein n is an integer. Therefore, ωₑτ≠nπ is an indispensable condition to be met for the two-path bandpass sampling method.

When sin(φp₂−φ₁);o, i.e., φ₂−φ₁=ω_{c}τ≠nπ, with some mathematical operations of (4) and (5), I(t) and Q(t) can respectively be represented as the linear combination of the output signals S₁(f) and S₂(t) of digital lowpass filters 720 and 721:

$$\begin{matrix}I ( t ) = \frac{{S}_{1} ( t ) sin ( {φ}_{2} ) - {S}_{2} ( t ) sin ( {φ}_{1} )}{sin ( {φ}_{2} - {φ}_{1} )} & ( 6 ) \\ Q ( t ) = \frac{{S}_{1} ( t ) cos ( {φ}_{2} ) - {S}_{2} ( t ) cos ( {φ}_{1} )}{sin ( {φ}_{2} - {φ}_{1} )} & ( 7 )\end{matrix}$$

From equations (6) and (7), it can be known that I(t) and Q(t) are only related with the initial phases φ₁ and φ₂ of the carrier relative to CLK₁ and CLK₂, and the two baseband digital sequence signals S₁ (f) and S₂(t) obtained after lowpass filtering. Wherein only the relative initial phases φ₁ and φ₂ are unknown, so I/Q separator 730 still needs an inital phase computing module. After cell search procedure, the midamble signal and pilot signal sent by the transmitter at the sender side have become known signals for the receiver at the receive side, so the initial phase computing module can compute the initial phases φ₁ and φ₂ of the carrier, by using the midamble signal or pilot signal.

Specifically, assume that the I(f) and Q(t) of the received midamble signal or pilot signal are I₀(t) and Q₀(t), and after the received midamble signal or pilot signal is filtered by digital lowpass filters 720 and 721, the output signals are S₁₀(t) and S₂₀(t). Thus, from equations (4) and (5), we can get:

$$\begin{matrix}{S}_{10} ( t ) = \sqrt{{I}_{0}^{2} ( t ) + {Q}_{0}^{2} ( t )} cos \{ {φ}_{1} + arc tan ( \frac{{Q}_{0} ( t )}{{I}_{0} ( t )} ) \} & ( 8 ) \\ {S}_{20} ( t ) = \sqrt{{I}_{0}^{2} ( t ) + {Q}_{0}^{2} ( t )} cos \{ {φ}_{2} + arc tan ( \frac{{Q}_{0} ( t )}{{I}_{0} ( t )} ) \} & ( 9 )\end{matrix}$$

Then, φ₁ and φ₂ can be calculated from equations (8) and (9), as follows:

$$\begin{matrix}{φ}_{1} = arc cos ( \frac{{S}_{10} ( t )}{\sqrt{{I}_{0}^{2} ( t ) + {Q}_{0}^{2} ( t )}} ) - arc tan ( \frac{{Q}_{0} ( t )}{{I}_{0} ( t )} ) & ( 10 ) \\ {φ}_{2} = arc cos ( \frac{{S}_{20} ( t )}{\sqrt{{I}_{0}^{2} ( t ) + {Q}_{0}^{2} ( t )}} ) - arc tan ( \frac{{Q}_{0} ( t )}{{I}_{0} ( t )} ) & ( 11 )\end{matrix}$$

After the initial phase computing module determines φ₁ and φ₂, I/Q separator 730 can process the received S₁(f) and S₂(f) according to equations (6) and (7), to get I(t) and Q(t) of the wanted user signal. I/Q separator 730 is placed behind the ADC, so the processed signal is digital sequence. For ease of explanation in equations, signal is still represented in form of f(t).

The principle of the bandpass sampling receiver is analyzed above in conjunction with FIG. 7. In practical applications, the proposed bandpass sampling receiver will operate as follows: first, determining the sampling clock frequency of the ADC

$${f}_{s} = \frac{{f}_{c}}{N} > B$$

according to the carrier frequency f_{c} and user signal bandwidth B of the received RF signal; then, determining the relative delay τ between the sampling clocks of the two ADCs according to the necessary condition of the two -path bandpass sampling ω_{c}τ≠nπ; afterwards, the receiver receives pilot signal or midamble signal from the transmitter, and determines the relative initial phases of the carrier in the initial phase computing un it in I/Q separator 730, according to equations (10) and (11); after the relative initial phases of the carrier are determined, the receiver can process the received signal in I/Q separator 730 according to equations (6) and (7) and by using the parameters computed in the above steps, to get two orthogonal digital components of the wanted user signal, and sends them to subsequent DSP unit 740 for further analysis.

In a preferred embodiment of the present invention, in order to further simplify the I/Q separation procedure, the relative delay τ between the two paths of clock signals CLK₁ and CLK₂ can be further constrained to satisfy

$${ω}_{c} τ = ( 2 n \pm \frac{1}{2} ) π .$$

To ensure the relative delay τ between CLK₁ and CLK₂ can meet condition that

$${ω}_{c} τ = ( 2 n \pm \frac{1}{2} ) π ,$$

if assuming

$${ω}_{c} τ = \frac{π}{2} ,$$

the relative delay

$$τ = \frac{1}{2 π {f}_{c}} \frac{π}{2} = \frac{1}{4 {f}_{c}} = \frac{{T}_{c}}{4} ,$$

wherein T_{c} is the carrier cycle, and two sampling clock signals can be generated readily with the method as shown in FIG. 8. As best shown in FIG. 8, first, LO 801 generates a signal with frequency twice the carrier frequency of the received signal. The signal is split into two paths of orthogonal clock signals having the same frequency as the carrier frequency of the signal by the ½ splitter 802, thus it can be guaranteed that the phase shift is IC under carrier frequency ω_{c}. Finally, two 1/N splitters 803 and 804 decrease the frequency of the two paths of orthogonal signals to 1/N of the former, i.e. the sampling clock frequency, thus the wanted sampling c locks CLK₁ and CLK₂ can be obtained, wherein ½ splifter 802 is required to ensure that the relative delay X between CLK₁ and CLK₂ can keep unchanged.

After the RF signal is sampled with the two paths of clock signals satisfying the condition

$${ω}_{c} τ = ( 2 n \pm \frac{1}{2} ) π ,$$

equations (6) and (7) can be further simplified.

$$\begin{matrix}When {φ}_{2} - {φ}_{1} = {ω}_{c} τ = ( 2 n + \frac{1}{2} ) π , & \\ I ( t ) = {S}_{1} ( t ) cos ( {φ}_{1} ) - {S}_{2} ( t ) sin ( {φ}_{1} ) & ( 12 ) \\ Q ( t ) = {S}_{1} ( t ) sin ( {φ}_{1} ) - {S}_{2} ( t ) cos ( {φ}_{1} ) & ( 13 ) \\ \begin{matrix}I ( t ) + j Q ( t ) = [ {S}_{ 1} ( t ) - j {S}_{ 2} ( t ) ] [ cos ( {φ}_{ 1} ) - j sin ( {φ}_{ 1} ) ] \\ = [ {S}_{1} ( t ) - j {S}_{2} ( t ) ] {ⅇ}^{- j {φ}_{1}}\end{matrix} \\ When {φ}_{2} - {φ}_{1} = {w}_{c} τ = ( 2 n - \frac{1}{2} ) π , & ( 14 ) \\ I ( t ) = {S}_{1} ( t ) cos ( {φ}_{1} ) + {S}_{2} ( t ) sin ( {φ}_{1} ) & ( 15 ) \\ Q ( t ) = - {S}_{1} ( t ) sin ( {φ}_{1} ) + {S}_{2} ( t ) cos ( {φ}_{1} ) & ( 16 )\end{matrix}$$

Q(I)+jI(t)=[S₂(t)+jS₁(t)][cos(φ₁)+j sin(φ₁)]=[S₂(t)+jS₁(t)]e^{jφ1} (17)

According to equations (12) to (17), I(t) and Q(t) are only related with the initial phase A, of the RF carrier relative to CLK₁ and the two lowpass filtered baseband digital sequence signals S₁ and S₂, wherein only 100 ₁ is unknown. Thus, the initial phase computing unit in I/Q separator 730 can compute the relative initial phase φ₁ of the carrier by taking advantage of the known midamble signal or pilot signal, with equation (10).

$${φ}_{1} = arc cos ( \frac{{S}_{10} ( t )}{\sqrt{{I}_{0}^{2} ( t ) + {Q}_{0}^{2} ( t )}} ) - arc tan ( \frac{{Q}_{0} ( t )}{{I}_{0} ( t )} ) \qquad ( 18 )$$

After φ₁ is computed in the initial phase computing unit, I/Q separator 730 can process the received S₁(t) and S₂(t) with equations (12) and (13) or (15) and (16), to compute I(t) and Q(t) of the user signal.

According to equations (14) and (17), I(t) and Q(t) of the user signal can be obtained by rotating the sampled sequence with a certain phase q),. This sampling method is equivalent in effect to the method of using orthogonal carrier signal to quadrature modulate the received signal, and that's why this sampling method is called quadrature bandpass sampling.

In the I/A separation procedure in the above -mentioned preferred embodiment, if the two clock signals are synchronized with the carrier with specific phase relationship as

$${φ}_{1} = 2 k π + \frac{n π}{2} , n = 0 , 1 , 2 , 3 ,$$

the I/Q separation procedure can be further simplified, and the orthogonal user signals can be obtained directly from the sampled sequences. But in different situations, there may be sign change between the orthogonal user signals and the output signal of the digital filter, specifically as follows:

$$\begin{matrix}When {φ}_{1} = 2 k π and {ω}_{c} τ = ( 2 n \pm \frac{1}{2} ) π , & \\ I ( t ) = {S}_{1} ( t ) & ( 19 ) \\ Q ( t ) = ∓ {S}_{2} ( t ) \\ When {φ}_{1} = ( 2 k + \frac{1}{2} ) π and {ω}_{c} τ = ( 2 n \pm \frac{1}{2} ) π , & ( 20 ) \\ I ( t ) = ∓ {S}_{2} ( t ) & ( 21 ) \\ Q ( t ) = - {S}_{1} ( t ) \\ When {φ}_{1} = ( 2 k + 1 ) π and {ω}_{c} τ = ( 2 n \pm \frac{1}{2} ) π , & ( 22 ) \\ I ( t ) = - {S}_{1} ( t ) & ( 23 ) \\ Q ( t ) = \pm {S}_{2} ( t ) \\ When {φ}_{1} = ( 2 k + \frac{3}{2} ) π and {ω}_{c} τ = ( 2 n \pm \frac{1}{2} ) π , & ( 24 ) \\ I ( t ) = \pm {S}_{2} ( t ) & ( 25 ) \\ Q ( t ) = {S}_{1} ( t ) & ( 26 )\end{matrix}$$

When

$${φ}_{1} = 2 k π + \frac{n π}{2} , n = 0 , 1 , 2 , 3$$

is computed by the initial phase determining unit, I/Q separator 730 can recover the user signal with equations (19-26) under different conditions: using two paths of baseband digital signals as the real part and imaginary part of the complex signal; rotating the phase of the complex signal with n times 90 degree, and then taking the real part and imaginary part of the complex signal as the corresponding separated in-phase signal and the quadrature signal respectively, to simplify the l/Q separation procedure at most.

The aforementioned I/Q separator and the initial phase computing unit therein can be implemented in software, or in specific hardware to implement the algorithms in the equations, or in combination of both.

Beneficial Results of the Invention

As described above, with regard to the bandpass sampling receiver as proposed in the present invention, the baseband signal can be obtained by AD converting the RF signal with bandpass sampling method, and thus this leads to omission of analog mixers and IF filters that are usually bulky, power consuming and difficult to be integrated, which greatly simplifies the receiver. architecture, and avoids problems like nonlinear effects, image frequency interference, DC offset and mixer noise in conventional receivers. With bandpass sampling techniques, the sampling frequency can be significantly lower than the carrier frequency, thus the requirement for ADC's performance can be lowered. The present invention also overcomes the deficiency of two-path sampling methods in prior art, and the proposed receiver architecture can be applied in various situations through setting the delay X between two sampling clock signals to meet the condition ωₑτ≠nπ. Moreover, when wₑτ=(2± 1/2)π, the computation procedure for I/Q separation can be simplified, especially when the sampling clock signals are phase synchronized with the carrier signal and

$${φ}_{1} = 2 k π + \frac{n π}{2} , n = 0 , 1 , 2 , 3 ,$$

the orthogonal components of the user signal can be obtained directly from the sampled signal, which can further simplify the computation procedure for I/Q separation. The details of I/Q separation are also offered in the present invention, which is of great help for the proposed receiver to be applied practically.

It is to be understood by those skilled in the art that the bandpass sampling receiver as disclosed in this invention can be modified considerably without departing from the spirit and scope of the invention as defined by the appended claims.

1. A bandpass sampling receiver for receiving RF signals, comprising:
a first ADC, for converting the RF signal into the first path of digital signal under the control of the first sampling clock signal;
a second ADC, for converting the RF signal into the second path of digital signal under the control of the second sampling clock signal;
a signal separating unit, for separating the in-phase signal and the quadrature signal in the first path of digital signal and the second path of digital signal;
wherein the frequency of said first sampling clock signal and said second sampling clock signal is 1/N of that of said RF signal, and N is a natural number.

2. The receiver of claim 1, wherein there exists a relative delay τ between said first sampling clock signal and said second sampling clock signal, and the relative delay τ meets the condition ω_{c}τ≠nπ, where ω_{c} is the circular frequency of said RF signal and n is a natural number.

3. The receiver of claim 2, further comprising:
a first lowpass filter, for receiving said first path of digital signal and outputting the first path of digitally filtered baseband digital signal to said signal separating unit;
a second lowpass filter, for receiving said second path of digital signal and outputting the second path of digitally filtered baseband digital signal to said signal separating unit.

4. The receiver of claim 3, wherein said signal separating unit includes:
an initial phase calculating unit, for calculating the initial phases of said RF signal respectively relative to said first sampling clock signal and said second sampling clock signal, according to the known signal sent from the transmitter;
an I/Q signal separating unit, for separating the in-phase signal and the quadrature signal in the first path of digital signal and the second path of digital signal, according to the initial phases.

5. The receiver of claim 4, wherein said known signal can be one of the pilot signal and the midamble signal.

6. The receiver of claim 5, wherein said initial phase calculating unit calculates the initial phase with the following formula:
$${φ}_{1} = arc cos ( \frac{{S}_{10} ( t )}{\sqrt{{I}_{0}^{2} ( t ) + {Q}_{0}^{2} ( t )}} ) - arc tan ( \frac{{Q}_{0} ( t )}{{I}_{0} ( t )} ) and$$
$${φ}_{2} arc cos ( \frac{{S}_{20} ( t )}{\sqrt{{I}_{0}^{2} ( t ) + {Q}_{ 0}^{ 2} ( t )}} ) - arc tan ( \frac{{Q}_{0} ( t )}{{I}_{0} ( t )} )$$
wherein:
φ₁ is the initial phase of said RF signal relative to said first sampling clock signal;
φ₂ is the initial phase of said RF signal relative to said second sampling clock signal;
S₁₀(t) is the output signal after said known signal is filtered by said first lowpass filter;
S₂₀(t) is the output signal after said known signal is filtered by said second lowpass filter;
I₀ (t) is the in-phase component of said known signal;
Q₀(t) is the quadrature component of said known signal.

7. The receiver of claim 5, wherein said I/Q signal separating unit separates the in-phase signal and the quadrature signal in said first path of baseband digital signal and said second path of baseband digital signal:
$$I ( t ) = \frac{{S}_{1} ( t ) sin ( {φ}_{2} ) - {S}_{2} ( t ) sin ( {φ}_{1} )}{sin ( {φ}_{2} - {φ}_{1} )}$$
$$Q ( t ) = \frac{{S}_{1} ( t ) cos ( {φ}_{2} ) - {S}_{2} ( t ) cos ( {φ}_{1} )}{sin ( {φ}_{2} - {φ}_{1} )}$$
wherein:
I/(t) is said separated in-phase signal;
Q(t) is said separated quadrature signal;
S₁(t) is said first path of baseband digital signal;
S₂(t) is said second path of baseband digital signal;
φ₁ is the initial phase of said RF signal relative to said first sampling clock signal;
φ₂ is the initial phase of said RF signal relative to said second sampling clock signal; and φ₁=φ₁+ω_{c}τ.

8. The receiver in claim 1, wherein said relative delay fulfills equation
$${w}_{c} τ = ( 2 n \pm \frac{1}{2} ) π ,$$
where ω_{c} is the circular frequency of said RF signal, τ is said relative delay and n is a natural number.

9. The receiver of claim 4, further comprising:
an initial phase judging unit, for judging whether said calculated initial phase fulfills equation
$${φ}_{1} = 2 k π + \frac{n π}{2} , n = 0 , 1 , 2 , 3 ,$$
where φ₁ is the initial phase of said RF signal relative to said first sampling clock signal;
wherein said I/Q signal separating unit takes said first path of baseband digital signal and said second path of baseband digital signal respectively as the real part and the imaginary part of the complex signal if the initial phase fulfills the equation, then shifts the phase of the complex signal by 2/ππ and takes the real part and the imaginary part of the obtained complex signal as said separated in-phase signal and quadrature signal.

10. A method for bandpass sampling the received signals, comprising:
(a) converting the RF signal into the first path of digital signal under the control of the first sampling clock signal;
(b) converting the RF signal into the second path of digital signal under the control of the second sampling clock signal;
(c) separating the in-phase signal and the quadrature signal in the first path of digital signal and the second path of digital signal;
wherein the frequencies of said first sampling clock signal and said second sampling clock signal are 1/N of that of said RF signal and N is a natural number.

11. The method of claim 10, wherein there exists a relative delay τ between said first sampling clock signal and said second sampling signal, and the relative delay τ meets condition ω_{c}τ≠nπ, where ω_{c} is the circular frequency of said RF signal and n is a natural number.

12. The method of claim 11, further comprising:
filtering said first path of digital signal, and outputting the first path of baseband digital signal obtained after filtering;
filtering said second path of digital signal, and outputting the second path of baseband digital signal obtained after filtering;
wherein the in-phase signal and the quadrature signal in the first path of baseband digital signal and the second path of baseband digital signal are separated in step (c).

13. The method of claim 12, wherein step (c) includes:
calculating the initial phases of said RF signal relative to said first sampling clock signal and said second sampling clock signal, according to the known signal sent by the transmitter;
separating the in-phase signal and the quadrature signal in said first path of baseband digital signal and said second path of baseband digital signal, according to the initial phases.

14. The method of claim 13- wherein said known signal can be one of the pilot signal and the midamble signal.

15. The method of claim 14, wherein said initial phases are calculated with the following formula:
$${φ}_{1} = arc cos ( \frac{{S}_{10} ( t )}{\sqrt{{I}_{0}^{2} ( t ) + {Q}_{0}^{2} ( t )}} ) - arc tan ( \frac{{Q}_{0} ( t )}{{I}_{0} ( t )} ) and$$
$${φ}_{2} arc cos ( \frac{{S}_{20} ( t )}{\sqrt{{I}_{0}^{2} ( t ) + {Q}_{ 0}^{ 2} ( t )}} ) - arc tan ( \frac{{Q}_{0} ( t )}{{I}_{0} ( t )} )$$
wherein:
φ₁ is the initial phase of said RF signal relative to said first sampling clock signal;
φ₂ is the initial phase of said RF signal relative to said second sampling clock signal;
S₁₀(t) is the output signal of said known signal after filtered by said first lowpass filter;
S₂₀(t) is the output signal of said known signal after filtered by said second lowpass filter;
I₀(t) is the in-phase component of said known signal;
Q₀(t) is the orthogonal component of said known signal.

16. The method of claim 14, wherein the in-phase signal and the quadrature signal in said first path of baseband digital signal and said second path of baseband digital signal are separated with the following formula:
$$I ( t ) = \frac{{S}_{1} ( t ) sin ( {φ}_{2} ) - {S}_{2} ( t ) sin ( {φ}_{1} )}{sin ( {φ}_{2} - {φ}_{1} )}$$
$$Q ( t ) = \frac{{S}_{1} ( t ) cos ( {φ}_{2} ) - {S}_{2} ( t ) cos ( {φ}_{1} )}{sin ( {φ}_{2} - {φ}_{1} )}$$
wherein:
I/(t) is said separated in-phase signal;
Q(t) is said separated orthogonal signal;
S₁(t) is said first path of baseband digital signal;
S₂(t) is said second path of baseband digital signal;
φ₁ is the initial phase of said RF signal relative to said first sampling clock signal;
φ₂ is the initial phase of said RF signal relative to said second sampling clock signal; and φ₂=φ₁ω_{c}τ.

17. The method of any one of claim 10, wherein said relative delay meets condition
$${w}_{c} τ = ( 2 n \pm \frac{1}{2} ) π ,$$
is the angular frequency of said RF signal, τ is said relative delay and n is a natural number.

18. The method of claim 13, further comprising:
judging whether said calculated initial phase meets the condition
$${φ}_{1} = 2 k π + \frac{n π}{2} , n = 0 , 1 , 2 , 3 ,$$
where φ₁ is the initial phase of said RF signal relative to said first sampling clock signal;
taking said first path of baseband digital signal and said second path of baseband digital signal respectively as the real part and the imaginary part of the complex signal if the initial phase meets the equation, then shifting the phase of the complex signal by 2/ππ and taking the real part and the imaginary part of the obtained complex signal as said separated in-phase signal and quadrature signal.
